(19) United States
(12) Patent Application Publication
(10) Pub. No.: US 2016/0162587 A1
(43) Pub. Date: Jun. 9, 2016

(54) PROCESS FOR PROVIDING A COMPUTER SERVICE AND COMPUTER SYSTEM FOR IMPLEMENTING THE PROCESS

(71) Applicant: BULL SAS, Les Clayes Sous Bois (FR)

(72) Inventors: Patrice MARTINEZ, GRENOBLE (FR); Landry Stephane ZENG EYINDANGA, GRENOBLE (FR); Jacques CAYUELA, LA TRONCHE (FR)

(21) Appl. No.: 14/964,160

(22) Filed: Dec. 9, 2015

(30) Foreign Application Priority Data
Dec. 9, 2014 (FR) 1462096

(51) Int. Cl. G06F 17/30; H04L 29/08

(52) U.S. Cl. CPC G06F 17/30867; H04L 67/10

(57) ABSTRACT

A process for providing a computer service via a search engine of the Internet to a user who has made a request for service via a terminal (TU) and an implementing system includes steps for creating executable tutorials, for searching by the search engine (MR) at least one tutorial (TE) in an executable format corresponding to the requested service, for automatic executing of the at least one tutorial that is found that makes it possible to provide the requested service, and for returning the result that is obtained to the terminal of the user (TU). The process applies to the use of computer tools such as software.

### FIELD OF THE INVENTION

The invention relates to a process for providing a computer service relative to at least one application program. The invention also relates to a computer system making it possible to implement the process.

Advantageously, the invention applies the use of computer tools, such as, for example, software.

Computer service is defined here as the implementation of a function of processing data or a sequence of actions/commands, or the chaining of one or more data-processing functions and one or more sequences of actions/commands or else the chaining of multiple sequences of actions/commands, of one or more application programs.

Application program is defined as a program that can be run by a computer or by a processor of a machine; these may be data-processing-type programs and/or control-type programs for a machine or a tool.

An application program of the data-processing type comprises digital data-processing functions; these may be image or text processing programs, video processing programs, or video or image publication programs on computer networks such as social networks.

A control-type application program runs sequences of commands for controlling a machine or a machine-tool.

Below, the application programs make it possible to carry out processing, whether this is processing digital data, images, or audio or video data, or to run sequences of actions or commands.

Machine is defined as a computer or a server or a machine-tool or a tool such as, for example, a robot.

Terminal is defined as a computer or a mobile phone or a tablet or any other device that is equipped with means for connecting to the Internet and at least one processor that can run recorded or downloaded programs.

### BACKGROUND OF THE INVENTION

To date, when a user desires to obtain a service that can be run by one or more application programs, he encounters difficulties and sometimes an inability to work based on his level of computer knowledge and the equipment that is available to him. This is the case when the user has a terminal and this terminal does not have (an) application program(s) that make(s) it possible to ensure the required service or the user does not know how to obtain the required service or else he does not have sufficient knowledge to find and to understand how to obtain said service from the application program(s) that can provide said service to the user.

In all of the cases, to obtain a computer service, the user has to know which application program is able to provide this service and how to use the application program to obtain the required service.

The solutions that are known to date are, for a user, to connect to the Internet, to go to forums or to do research from a search engine so as to find a tutorial describing all of the successive actions or steps to follow using the terminal, and to obtain the required computer service. The user also has the possibility of addressing an expert for acquiring the tutorial and then of following the successive steps described by the tutorial to finally obtain the required service.

This solution has the drawback of making it necessary for the user to manually carry out the following actions:
1. Finding the tutorial(s) that meet(s) the requirement(s),
2. Researching the application program(s) described in the tutorial(s),
3. Downloading, installing, and configuring the program(s) described in the tutorial(s),
4. Applying the steps of the tutorial to the application program(s).

All of these operations are tedious, long, and very often difficult to implement in particular for users who do not know the application programs, such as the office automation tools, the video or image processing programs, or else the Web services.

This invention has as its object to eliminate these drawbacks.

### SUMMARY OF THE INVENTION

With this invention, the users no longer need to know the application program(s) with which the service can be obtained. The user directly obtains the result from a request for computer service instead of a tutorial that guides him to obtain said computer service.

Actually, according to this invention, the user directly obtains the result and no longer has to be concerned about tedious steps for identification of the program(s) to be used, installation, and training on the use of said program(s).

This invention more particularly has as its object a process for providing a computer service via a search engine of the Internet to a user who has made a request for service via a terminal (TU), with said terminal being connected to the Internet, primarily characterized in that it comprises:
a) The search by the search engine for at least one tutorial in an executable format corresponding to the requested service,
b) The automatic execution of the at least one tutorial that is found, making it possible to provide the requested service,
c) The restoration of the result obtained at the user terminal (TU).

Advantageously, the process comprises a preliminary phase A) for the creation of tutorials in an executable format and/or for the conversion of tutorials existing in an executable format.

According to another characteristic, the preliminary phase A) also comprises the recording of said executable tutorials on one or more servers connected to the Internet.

According to another characteristic, step b) comprises:
The implementation by the executable tutorial of successive steps corresponding to an automatic chaining of commands applied to one or more application programs used for the requested service.

According to another characteristic, the executable tutorial commands are applied by means of a program for controlling the application program. Advantageously, a program for orchestrating the service makes it possible to chain multiple steps of the executable tutorial or to chain the running of multiple executable tutorials.

According to another characteristic, the process also comprises a step for recording a catalog in the form of a table of reference data attributed to tutorials in the executable format allowing access to and selection of the executable tutorial(s) required for the requested service.

Advantageously, the computer service comprises data processing on data that come in the form of a text or image or audiovisual file and/or the execution of commands.

According to another characteristic, the process comprises the downloading of the at least one executable tutorial on the terminal of the user and the automatic execution by said terminal or the automatic execution of the at least one tutorial by a server connected to the Internet on which said executable tutorial is recorded.

When the executable tutorial is run by a server connected to the Internet, the process also comprises the step of:
Transmission by the user, via the Internet, to said server of data to be processed in the form of a text or image or audiovisual data file and the restoration of the file that is processed via the connection to the Internet.

The invention also has as its object a system for providing a computer processing service for implementing the process according to any one of the preceding claims, primarily characterized in that it comprises:
Access to at least one executable tutorial by means of a search engine from a user terminal,
One or more servers for recording executable tutorials and for referencing and recording application programs,
At least one server for orchestrating the execution of service comprising a control program applying the commands of the executable tutorial(s) to the application program(s) corresponding to the requested service,
With the servers being connected to the Internet.

According to another characteristic, the server for execution of service also comprises an orchestration program for addressing the commands of the executable tutorial(s) to different application programs that are involved in providing the service.

Advantageously, the server(s) for orchestrating the execution of service (S4) is (are) located on the user terminal (TU) or on a remote computer server that can be accessed by the Internet (W).

According to another characteristic, the system also comprises an access by terminals of experts and/or editors of programs with at least one server for creating executable tutorials comprising one or more programs for developing executable tutorials.

According to another characteristic, the access to at least one executable tutorial comprises a Web application on a dedicated desktop or server that makes it possible to associate the service request with an executable tutorial.

According to another characteristic, the dedicated desktop or server that makes it possible to associate the service request with an executable tutorial comprises a Web application running a semantic search mechanism or a catalog of available executable tutorials.

### BRIEF DESCRIPTION OF THE DRAWINGS

Other special features and advantages of the invention will emerge from reading the following description given by way of illustrative and non-limiting example, with reference to the accompanying figures that show:

FIG. 1, a diagram of the steps of the process according to the invention,

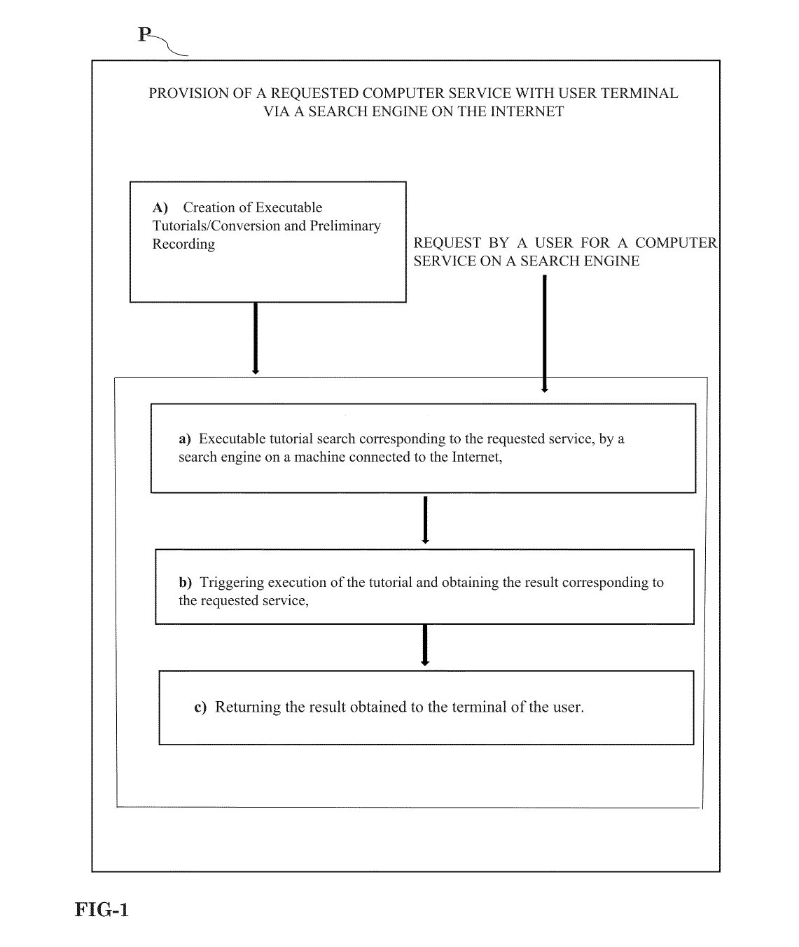

FIG. 2, a diagram of a system for implementing the process according to a first embodiment,

FIG. 3, a diagram of a system for implementing the process according to a second embodiment.

### DETAILED DESCRIPTION OF THE INVENTION

According to this invention, the provision of a computer service comprises, for a user, access to the means of a search engine, to the requested computer service, and the provision of the result without having to search for and/or to obtain the application program(s) that are necessary for performing the required computer processing.

For this purpose, the process P comprises a preliminary phase A) for the creation of tutorials in an executable format and/or for the conversion of tutorials in an executable format, i.e., in a format that can be run (executed) by a computer or any device that comprises a processor that makes it possible to run a computer program.

Thus, for the requested computer service, the tutorial writes in an executable format corresponding to this service, automatically implements all of the actions or steps that the user should have carried out to obtain said service. For example, to illustrate a simple service that consists in wanting to obtain the insertion of a watermark into a Word document, the user is to look in the tabs of the Word page and when he has found it, he must click on “Create,” then click on “Watermark,” and then insert the selected watermark. The executable tutorial that is created will automatically run the chaining of these commands on the Word application program.

Next, when a user makes his computer service request via his terminal on a search engine, the process P comprises these steps: a) for searching by the search engine of the tutorial in an executable format corresponding to the requested service; b) for automatic triggering and execution of the tutorial that is found, making it possible to provide the requested service; c) for returning the result that is obtained at the terminal of the user.

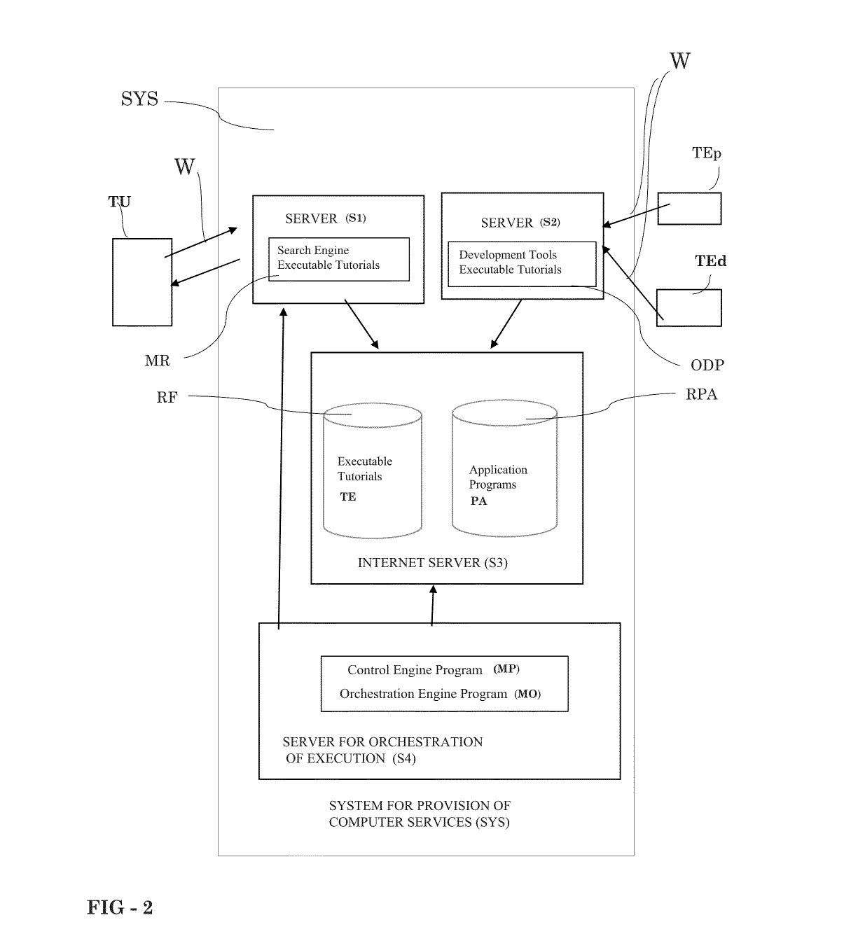

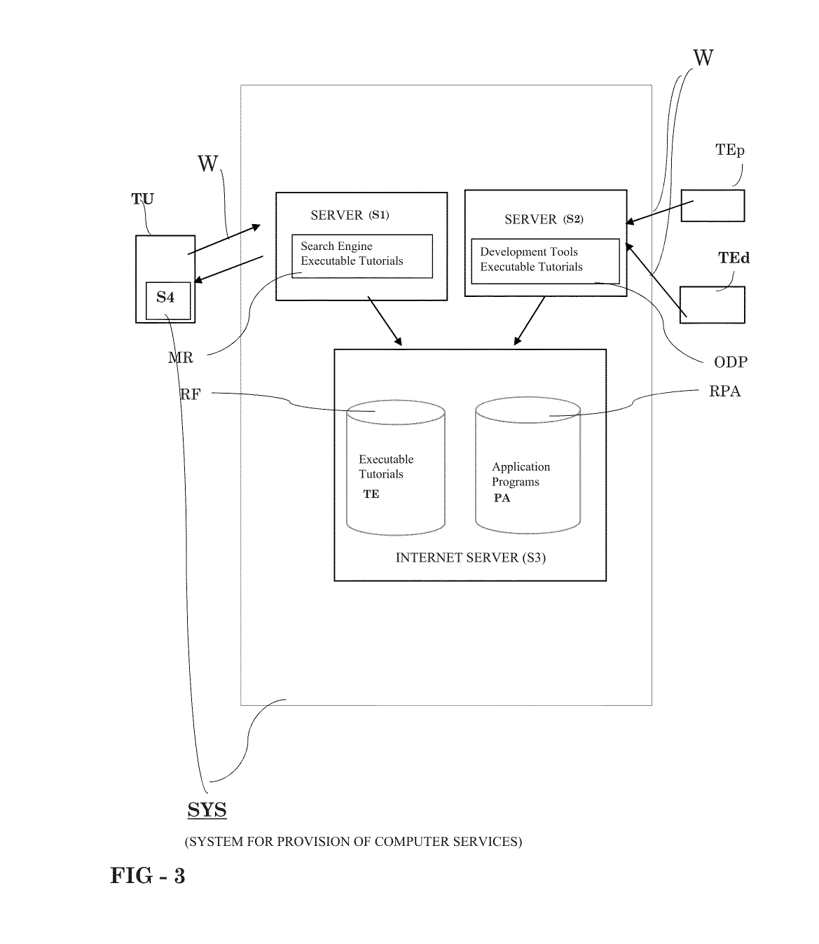

In this invention, interactions also take place among a terminal TU of a user, the Internet W, and the system for provision of computer service SYS illustrated in FIGS. 2 and 3. Interactions also take place among TEp expert terminals, the Internet W, and the system for provision of computer service SYS. Interactions also take place among TEd editor terminals, the Internet W, and the system for provision of service SYS.

The servers that are accessible via the Internet are referred to below as Internet servers.

The executable tutorials are created by experts or editors. The experts or editors connect to existing Internet servers for creating executable tutorials by means of tools existing on Internet servers. These are tools for development of programs bearing the reference ODP in FIGS. 2 and 3. Such tools are present in said Internet servers as illustrated in FIGS. 2 and 3 by the server S2.

The executable tutorials are loaded on Internet servers, illustrated by the server S3 in FIGS. 2 and 3, as they are created. Advantageously, the recorded executable tutorials are referenced in a catalog in the form of a table of reference data RF, with each executable tutorial thus being referenced by a “reference” datum. This table allows quick access and the selection of the executable tutorial(s) required for the requested service.

Application programs PA are also recorded on the Internet servers S3 and referenced by means of a table for reference data RPA also making it possible to have quick access to the desired application program.

The user connects with his terminal TU to the Internet and makes a request for service on a search engine MR. A desktop or Internet server S1 makes it possible to associate the service request of the user with an executable tutorial of the catalog RF.

During the execution of the tutorial, the commands of the executable tutorial of the requested service are applied by means of a control program or control engine MP of the application program PA and by means of an orchestration program or an orchestration engine OP. The orchestration engine OP is used when multiple executable tutorials are to be run. Actually, the orchestration engine is able to continue the execution of said executable tutorials.

The programs of control engine MP and orchestration engine MO are on the server for execution of service S4 illustrated in FIGS. 2 and 3.

In the embodiment of the system SYS illustrated by the diagram of FIG. 2, the server S4 for orchestrating the execution of the service is a remote computer server accessible from the terminal TU via the Internet W.

In the embodiment of the system SYS illustrated by the diagram of FIG. 3, the server S4 for orchestrating the execution of service is a computer server that is located in the user terminal TU. This configuration that corresponds to the second embodiment is advantageously used for terminals that have processing capacities and bandwidth that are adequate, such as, for example, a computer (PC). This configuration makes it possible in particular to download the executable tutorial(s) TE but also, if necessary, to download the application program(s) PA.

### Practical Embodiment

In the example that is given, the system for provision of service corresponds to the embodiment that is illustrated by FIG. 3. The server S4 for orchestrating the execution of service is implemented in the user terminal TU.

The requested service corresponds to processing on a photo.

The user wants to suppress the red eyes of a photo.

The user connects to the Internet with his terminal TU. He makes the request for the service “red-eye suppression” on the search engine MR. The desktop or Internet server S1 associates the request of the user with the executable tutorial that responds to this service from the reference table RF.

The search engine finds the executable tutorial that makes it possible to do this processing automatically and, in this particular example, returns it to the user by a loading on the terminal TU of the user. The tutorial can be executed by an instance of the photo processing application, i.e., the application program “Photoshop” installed on the server S3 of application program RPA. The user clicks on his terminal TU to select the executable tutorial. The screen of the terminal TU makes possible the selection of the photo, then the orchestration engine MO of the server S4 transmits the execution of the tutorial to the control engine MP for the automatic execution that, for example, sequentially injects the commands to the application program “Photoshop” via the operating system of the terminal TU.

Advantageously, the result is returned to the user at the electronic address indicated by means of a mail dispatch service available to the search engine MR.

According to another example, the requested service can correspond to the chaining of two sequences: one consists of a data processing such as “red-eye suppression in a photo” and the other consists of a command such as “publish the photo on a social network.”

This chaining can be provided in an executable tutorial or be obtained by the chaining of two executable tutorials. In the case where two executable tutorials are necessary, an executable tutorial will be used for automatically implementing the necessary steps for obtaining “a photo without red eyes” and a second executable tutorial will implement the steps for executing the command for publication of the photo that is processed on a social network, and thus for obtaining the final result. The orchestration engine MO then controls the chaining of “processing” and “publication” sequences.

When the server S1 is a dedicated desktop, i.e., a Web application for the provision of computer services, the user has the possibility of formulating his request with predetermined criteria such as:
Desired name(s) of the image processing software: arbitrary
Desired location of the software: arbitrary
Cost of the service: free
Desired run time: arbitrary
Desired restore site: pierre.durand@xmail.fr.

For this purpose, the Web application comprises a dialog interface with the user.

The description of the orchestration of services (orchestration engine MO) is provided by a program that is written in a dedicated language “DSL: Domain-Specific Language” for describing a service call process. The description of the control (control engine MP) of the application program is provided by a program that is written in a dedicated language “DSL: Domain-Specific Language” for controlling an application. The programming of the orchestration and control engines that are capable of interpreting these two DSL programs relies on knowledge that is general for a computer scientist, and these two engines are coded in conventional computer language (C language or Java, for example) to be used for the user terminal TU or the server S4. This coding in conventional language also relies on knowledge that is general for a computer scientist.

1. Process for providing a computer service via a search engine of the Internet to a user who has made a request for service via a terminal (TU), with said terminal being connected to the Internet, characterized in that it comprises:
a) The search by the search engine (MR) for at least one tutorial (TE) in an executable format corresponding to the requested service,
b) The automatic execution of the at least one tutorial that is found, making it possible to provide the requested service,
c) The restoration of the result obtained at the terminal of the user (TU).

2. Process for providing a computer service according to claim 1, wherein it comprises a preliminary phase A) for creating tutorials in an executable format and/or for converting tutorials existing in an executable format.

3. Process for providing a computer service according to claim 2, wherein the preliminary phase A) also comprises the recording of said executable tutorials on one or more servers (S3) connected to the Internet.

4. Process for providing a computer processing service, according to claim 1, wherein the stage b) comprises:
The running by the executable tutorial of successive steps corresponding to an automatic chaining of commands applied to one or more application program(s) that is/are used for the service requested.

5. Process for providing a computer service according to claim 4, wherein the commands of the executable tutorial are applied by means of a program for controlling the application program and by means of a program for orchestrating the service for chaining multiple steps of the executable tutorial and/or for chaining the running of multiple executable tutorials.

6. Process for providing a computer service according to claim 1, wherein it also comprises a step for recording a catalog in the form of a reference data (RF) table attributed to the tutorials in the recorded executable format, making possible the access and the selection of the executable tutorial or tutorials required for the service requested.

7. Process for providing a computer processing service, according to claim 1, wherein the computer service comprises a processing of data on data that come in the form of a text or image or audiovisual file and/or the execution of commands.

8. Process for providing a computer processing service, according to claim 1, wherein it comprises the downloading of the at least one executable tutorial on the terminal (TU) of the user and the automatic execution by said terminal, or the automatic execution of the at least one tutorial by a server that is connected to the Internet on which said executable tutorial is recorded.

9. Process for providing a computer processing service, according to claim 8, wherein when the executable tutorial is run by a server connected to the Internet, the process also comprises the step of:
Transmission by the user, via the Internet, to said server of data to be processed in the form of a text or image or audiovisual data file and the restoration of the file that is processed via the connection to the Internet.

10. System for providing a computer processing service for implementing the process according to claim 1, wherein it comprises:
Access to at least one executable tutorial by means of a search engine (MR) from a user terminal (TU),
One or more servers (S3) for recording executable tutorials and for referencing and recording application programs,
At least one server (S4) for orchestrating the execution of service comprising a control program applying the commands of the executable tutorial(s) to the application program(s) corresponding to the requested service,
with the servers being connected to the Internet.

11. System for providing a computer processing service according to claim 10, wherein the server (S4) for execution of service also comprises an orchestration program for addressing the commands of the executable tutorial(s) to the different application programs that are involved for providing the service.

12. System for providing a computer processing service according to claim 10, wherein the server(s) (S4) for orchestrating the execution of service is (are) located on the user terminal (TU) or on a remote computer server that is accessible by the Internet (W).

13. System for providing a computer processing service according to claim 10, wherein it also comprises an access by terminals of experts and/or editors of programs with at least one server (S2) for creating executable tutorials that comprise one or more programs for development of executable tutorials.

14. System for providing a computer processing service according to claim 10, wherein access to at least one executable tutorial comprises a Web application on a dedicated desktop or server (S1) that makes it possible to associate the service request with an executable tutorial.

15. System for providing a computer processing service according to claim 14, wherein the dedicated desktop or server (S1) making it possible to associate the request for service with an executable tutorial comprises a Web application that runs a semantic search mechanism or a catalog of available executable tutorials.
